(19) United States
(12) Patent Application Publication
(10) Pub. No.: US 2006/0096959 A1
(43) Pub. Date: May 11, 2006

(54) Method for welding joint partners by means of an extruded shaped piece of welding filler, and also such a shaped piece for use during welding

(75) Inventors: Christoph Heimerdinger, Langenargen (DE); Roland Lang, Woerth (DE); Peter Mueller-Hummel, Leitershofen (DE); Frank Palm, Munich (DE)

Correspondence Address: CROWELL & MORING LLP;INTELLECTUAL PROPERTY GROUP, P.O. BOX 14300, WASHINGTON, DC, 20044-4300, US

(73) Assignee: EADS Deutschland GmbH, Ottobrunn (DE)

(21) Appl. No.: 11/268,469

(22) Filed: Nov. 8, 2005

(30) Foreign Application Priority Data
Nov. 9, 2004 (DE) 10 2004 054 346.1

(51) Int. Cl. B23K 26/20

(52) U.S. Cl. 219/121.64

(57) ABSTRACT

In a method for welding joint partners, a shaped piece that is extruded out of a welding filler material is arranged between joint partners, which are to be connected, in such a way that it is in contact with both joint partners. The section of the shaped piece is matched to the geometry of at least one of the joint partners, so that before welding, the shaped piece is connected to the at least one joint partner in a form-locking manner. Subsequently, the joint partners are welded together along the shaped piece.

### BACKGROUND AND SUMMARY OF THE INVENTION

This application claims the priority of German patent document 2004 054 346.1, filed Nov. 9, 2004, the disclosure of which is expressly incorporated by reference herein.

The present invention relates to a method for welding members (referred to herein as “joint partners”) using an extruded shaped piece made of welding filler, especially in a T-joint or butt joint, and to such a shaped portion for use during welding.

The use of welding fillers in welding engineering is well known. However, in the classic vapor-capillary-based laser beam welding of aluminum materials substantial effort is required to position, supply and introduce the welding filler, which may be, for example, in the form of a wire. Moreover, substantial expenditures are also required for control systems and sensor technology to check the wire supply continuously, particularly its quantity and position. Welding filler wire that is supplied incorrectly or in a fluctuating manner, in terms of quantity or position can disturb the laser beam or even interrupt it, causing process instabilities. Furthermore, when there is uneven mixing of welding filler wire and basic material(s), non-reproducible connection properties can result. Welding filler wires have the disadvantage, moreover, that they have a relatively large surface area in relation to their volume, so that impurities or gases are also introduced into the welding material, rapidly and unintentionally, resulting in excessive pore formation as a rule.

Strip-shaped welding fillers have also been used. Such a strip must also always be handled as a third object, since it is not fixedly connected to any of the joint partners. In addition, the small cross section of such strip-shaped welding fillers gives rise to significant handling problems, since the “soft” strip can become deformed in an undesirable manner, under its own weight. In the case of very long welded seams (>1000 mm), such as occur, for example, in pressurized aircraft fuselage shells, this property necessitates extremely elaborate and expensive handling technology. The positioning of the strip in relation to the joint position is thus extremely difficult.

One object of the present invention is to provide an improved welding method in which the welding filler can be introduced in a reliable and reproducible manner.

Another object of the invention is to provide a welding method that is more economical then the known techniques.

Still another object of the invention is to provide a method which achieves an improved and less expensive production of aluminum structures in terms of welding techniques for aeronautical engineering.

These and other objects and advantages are achieved by the welding method according to the invention, particularly for T-joints or butt joints, in which a shaped piece that is extruded out of welding filler is arranged between joint partners that are to be connected, in such a manner that it is in contact with both joint partners. The cross section of the shaped piece is matched to the geometry of at least one of the joint partners in such a way that, before welding, the shaped piece can be connected to the at least one joint partner in a form-locking (or positive-locking) manner. Subsequently the joint partners are welded together along the shaped piece.

The use of an extruded shaped piece of welding filler makes it possible to achieve form-locking, reproducible positioning of the welding filler so that, on the one hand, the process control is simplified (since corresponding positioning and control devices are not required to supply the welding filler), and on the other hand, the reproducibility of the welded connection is markedly improved. Thus, advantageously even higher process speeds are possible, increasing productivity. A further advantage lies in the fact that less waste is produced and the scale of after-treatment decreases significantly, lowering the costs of production overall.

Because the shape is matched to the geometry of the joint partners (or at least one joint partner), the shaped piece can be connected to the joint partners (or the at least one joint partner) in a form-locking manner simply by pushing it on with a corresponding clamping effect. The form-locking connection guarantees that the shaped piece and joint partner cannot come undone even without force transmission or in the case of interrupted force transmission.

When producing a T-joint connection it is expedient to use a shaped piece that has only one recess matched to the geometry of one of the joint partners for the form-locking connection. In this case, the recess of the shaped piece is pushed onto the corresponding joint partner, and is then positioned or held in relation to the second joint partner in such a way that the shaped piece rests substantially on the second joint partner.

When two joint partners are connected in a butt joint, it is particularly advantageous to use a shaped piece that has two recesses, whose shape is matched, in each case, to that of the joint partners for the form-locking connection. In this case, the shaped piece is arranged between the two joint partners, and is connected to them in a form-locking manner by pushing onto each of them.

It is particularly advantageous that welding is effected by means of laser beam welding. In addition, of course other known fusion welding methods can be used.

The objects of the invention are further achieved by providing the welding filler in the form of an extruded shaped piece for use during welding. The extruded shaped piece has at least one first recess that is matched to the geometry of a first joint partner so that it can be connected to the first joint partner in a form-locking manner by pushing it on, with a corresponding clamping effect.

Moreover, it two joint partners are to be connected together in a butt joint, it is particularly advantageous if the extruded shaped piece has a second recess, whose shape is matched in a similar manner to the geometry of the second joint partner, so that it can be connected to both joint partners in a form-locking manner by pushing it on, with the accompanying clamping effect.

Furthermore, it is expedient that the outer shape of the shaped piece corresponds to the geometry of a welded seam that is to be produced, which simplifies the welding process and improves the quality of the welded connection that is produced.

When producing a T-joint connection in accordance with the invention, it is particularly advantageous if the shaped piece has a substantially triangular cross section with equal sides, and with a substantially u-shaped first recess being formed between the equal sides. Of course, a shaped piece that has an asymmetrical, triangular cross section can also be used; that is, the side length and also the angles can be selected to be of any size.

It is also expedient that the first recess is formed or arranged symmetrically so that a symmetrical welded connection can be produced. Moreover, for the connection of two joint partners in the butt joint, it is advantageous that the extruded shaped piece has a cross section that is similar to that of a double T-profile section, and that the recesses that are formed by such profile section are matched to the geometry of the respective joint partners. The recesses then extend in the longitudinal direction of the shaped piece.

In an advantageous embodiment of the invention, the shaped piece that is formed so that it is similar to a double T-profile section is outwardly convex in a substantially triangular form. As a result, the geometry of the welded seam is reproduced, having a positive effect upon the welded seam that is to be produced.

As a result of the use of the shaped piece in accordance with the invention, no additional welding filler is required, so that supplying and positioning the welding filler in a manner involving difficult handling does not come into question. This technique noticeably improves the process and creates a reproducible welded connection.

Other objects, advantages and novel features of the present invention will become apparent from the following detailed description of the invention when considered in conjunction with the accompanying drawings.

### BRIEF DESCRIPTION OF THE DRAWINGS

FIG. 1. is a perspective schematic depiction of a first embodiment of the invention for producing a T-joint connection; and

FIG. 2 is a schematic perspective view of a further embodiment, for producing a butt-joint connection.

### DETAILED DESCRIPTION OF THE DRAWINGS

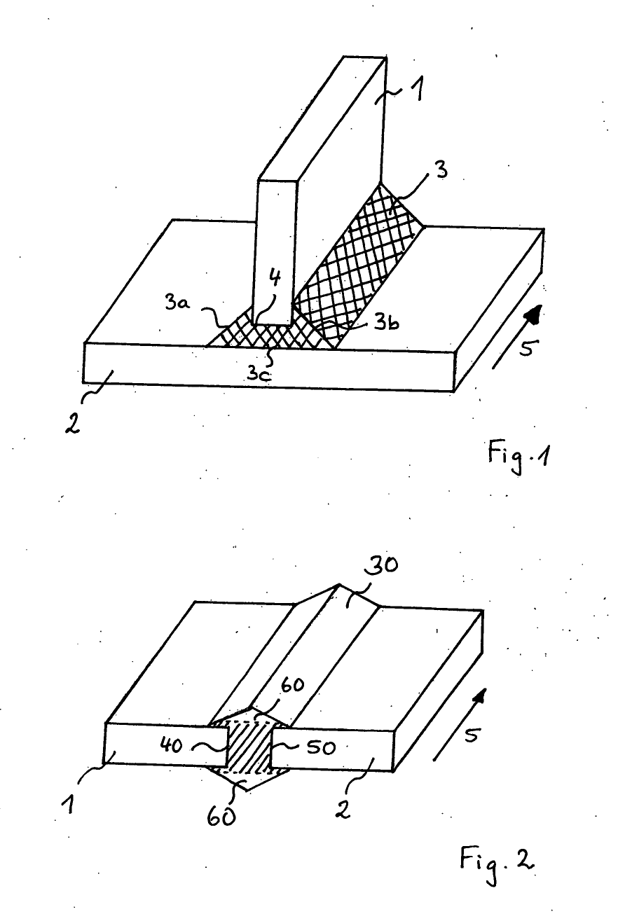

FIG. 1 shows in a diagrammatic, three-dimensional representation a T-joint connection of two joint partners 1, 2. A shaped piece arranged between the joint partners 1, 2 is produced by means of extrusion and consists of any welding filler, such as, for example, an AlSi₁₂, AlSi₅ or AlMg₅ alloy. In addition, of course, other alloys that are suitable as welding fillers can be used. By producing the shaped piece 3 by extrusion, a certain shape is introduced into the shaped piece 3 in a simple and effective manner, so that in turn, a reproducible and form-locking arrangement of the welding filler, that is required for a high-quality welded connection is possible.

As can be seen from FIG. 1, the shape of the shaped piece 3 is matched to the first joint partner 1 (for example a stringer or frame), and has a substantially triangular cross-section with equal sides 3a, 3b. A recess between the equal sides 3a, 3b is matched to the shape of the first joint partner 1 for a form-locking connection, and has a substantially u-shaped or rectangular configuration. Of course, a shaped piece with an asymmetrical cross section can also be used.

In order to weld the joint partners 1, 2, the shaped piece 3 is first connected to the first joint partner 1 by pushing the recess 4 onto one side of the first joint partner 1, so that it engages in a form-locking manner. The clamping effect of the recess 4 then suffices to secure the first joint partner 1 so that the connection does not come undone even without force transmission or in the case of interrupted force transmission. Subsequently, with the shaped piece 3 clamped thereon the first joint partner 1 is positioned or held so that the side 3c that lies between the equal sides 3a, 3b of the shaped piece 3 rests on the second joint partner 2 (for example a skin panel). If applicable, the first joint partner 1 or the shaped piece 3, as the case may be, is fixed with suitable means in order to avoid slippage. Afterwards, the joint partners 1, 2 are welded along the shaped piece 3, (in the direction that is denoted by reference numeral 5 in FIG. 1). In this connection, the substantially triangular cross-section of the shaped piece 3 reproduces essentially the desired shape of the welded seam.

FIG. 2 is a diagrammatic, three-dimensional representation of a further exemplary embodiment in which the two joint partners 1, 2 are to be connected together in a butt joint. As in the case of the embodiment in accordance with FIG. 1, a shaped piece 30 is arranged between the two joint partners 1, 2. The shaped piece 30 consists in turn of any welding filler, and is produced by means of extrusion in order to match its shape to that of the joint partners 1, 2 that are to be connected in a simple manner. The cross section of the shaped piece 30 is then formed in essentially a double T-profile section, as indicated diagrammatically by the hatched area in FIG. 2. As a result of the substantially double T-shaped configuration, recesses 40, 50 are formed that extend in the longitudinal direction of the shaped piece 30 and are each matched to the shape of the joint partners 1, 2 that are to be connected. That is, the recesses 40, 50 have a substantially u-shaped or rectangular cross-section in order to receive the joint partners 1, 2. The outer shape of the shaped piece 30 is matched to the shape of a welded seam that is to be produced. For this purpose, the shaped piece 30 is outwardly convex on both sides in a triangular form, as denoted by reference numeral 60 in FIG. 2. The convex portions follow on from the sides of the shaped piece that tend at right angles to the sides provided with the recesses 40, 50. The cross section of the shaped piece 30 is thus like a double arrow, whose points are formed by the triangular convex portions 60.

In order to weld the joint partners 1, 2 in the butt joint, the shaped piece 30 is arranged between and fixed to both joint partners 1, 2 in a form-locking manner. For this purpose, the first recess 40 of the shaped piece 30 is pushed onto the first joint partner 1, and the second recess 50 is pushed onto the second joint partner 2 in a corresponding manner. As a result of the clamping effect between recesses 40 and 50 and joint partners 1 and 2 respectively, a form-locking connection is guaranteed. Subsequently, the joint partners 1, 2 are connected together by welding along the shaped piece 30, in the direction of the arrow 5. As a result of the triangular convex portions 60 of the shaped piece 30, the shape of a welded seam that is to be produced is more or less reproduced, this being advantageous for a good joint connection.

The welding methods that are described in connection with FIGS. 1 and 2 are particularly useful in aeronautical engineering when applying reinforcing elements to skin panels, or when producing other aluminum structures.

As a result of the configuration in accordance with the invention of the welding filler, supply of the welding filler that is separate and thus difficult to reproduce does not come into question and so higher welding speeds are possible. Moreover, the costs of production are reduced, since less waste is produced and the scale of reworking is reduced.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method of forming a welded joint between joint partners, comprising:
arranging a shaped piece that is extruded out of welding filler between joint partners that are to be connected, in such a way that the shaped piece is in contact with both joint partners, a cross-section of the shaped piece conforming to geometry of at least a first one of the joint partners in such a way that, before welding, the shaped piece is positively engaged with the at least one first joint partner; and
welding the joint partners together along the shaped piece.

2. The method according to claim 1, wherein the shaped piece is lockingly connected to the least one joint partner by pushing it onto the at least one joint partner, with a corresponding clamping effect.

3. The method according to claim 2, wherein the shaped piece has at least one first recess that is matched to the geometry of the at least one first joint partner, for the form-locking connection.

4. The method according to claim 3, wherein the shaped piece has a second recess that is matched to geometry of a second one of the joint partners, for the form-locking connection.

5. The method according to claim 1, wherein the joint partners are connected by a fusion welding method.

6. The method according to claim 5, wherein laser beam welding is used.

7. An extruded shaped piece of welding filler for use in welding joint partners, said shaped piece comprising at least one first recess, whose shape is matched to geometry of a first joint partner, so that it can be lockingly connected to the first joint partner by pushing it onto the first joint partner, with a corresponding clamping effect.

8. The extruded shaped piece according to claim 7, further comprising:
a second recess whose shape is matched to geometry of a second joint partner, such that it can also be lockingly connected to the second joint partner by pushing it thereon, with a corresponding clamping effect.

9. The extruded shaped piece according to claim 8, wherein an outer shape of the shaped piece corresponds to the geometry of a welded seam that is to be produced.

10. The extruded shaped piece according to claim 7, having a substantially triangular cross section with equal sides, with a substantially u-shaped first recess being formed between the equal sides.

11. The extruded shaped piece according to claim 10, wherein the substantially u-shaped first recess is arranged symmetrically.

12. The extruded shaped piece according to claim 8, having a cross section that is substantially in the shape of a double T-profile section.

13. The extruded shaped piece according to claim 12, wherein recesses are formed by the double T-profile section that extend in a longitudinal direction of the shaped piece and have a substantially u-shaped cross section.

14. The extruded shaped piece according to claim 13, wherein the shaped piece has triangular convex portions pointing outwards.

15. A method of forming a joint between two members, comprising:
providing a shaped piece of welding filler material that has a cross sectional configuration that corresponds to a cross sectional configuration of an edge portion of at least a first one of said members;
attaching said shaped piece of welding filler material to said edge portion of said first one of said members;
placing said shaped piece of welding material, attached to said first one of said members, in contact with a surface of the second one of said members; and
welding said members along the shaped portion.

16. The method according to claim 15, wherein:
said joint is in the form of a T-joint between said members; and
in said placing step, said shaped piece of welding filler material is positioned against a side surface of said second one of said members.

17. The method according to claim 15, wherein:
said joint is formed as a butt joint between respective edges of said members;
said shaped piece of welding filler material has a cross section that includes first and second recesses that are configured to correspond to a cross sectional configuration of edge portions of both of said members;
in said placing step, said shaped piece of welding filler material is attached to the edge of the second one of said members, whereby the two members are held in a fixed relative position by said shaped piece of welding filler material prior to and during said welding step.

18. An element for joining two members by welding, wherein:
said element is made of a welding filler material;
said element is formed into a longitudinal shape that corresponds to a desired shape of a welded joint between said members; and
said element has a cross sectional configuration that conforms to a cross sectional configuration of a portion of at least one of said members that is to be welded, such that the element can be lockingly engaged with said at least one of said members and held in a fixed position during a welding operation.
